(19) United States
(12) Patent Application Publication
(10) Pub. No.: US 2021/0370880 A1
(43) Pub. Date: Dec. 2, 2021

(54) VEHICLE CONTROL APPARATUS, COMPUTER READABLE RECORDING MEDIUM, AND VEHICLE CONTROL SYSTEM

(71) Applicants: TOYOTA JIDOSHA KABUSHIKI KAISHA, Toyota-shi (JP); CMC CORPORATION, Nagoya-shi (JP)

(72) Inventors: Shin SAKURADA, Toyota-shi (JP); Naoyuki TAKADA, Toyota-shi (JP); Satoru SAKUMA, Nagakute-shi (JP); Yuki TATSUMOTO, Nagoya-shi (JP); Yasuhisa OHTA, Toyota-shi (JP); Tetsu YAJIMA, Nagoya-shi (JP)

(73) Assignees: TOYOTA JIDOSHA KABUSHIKI KAISHA, Toyota-shi (JP); CMC CORPORATION, Nagoya-shi (JP)

(21) Appl. No.: 17/221,369

(22) Filed: Apr. 2, 2021

(30) Foreign Application Priority Data
May 29, 2020 (JP) 2020-095064

(51) Int. Cl. B60R 25/31; B60R 25/04; B60R 25/23; B60R 25/20; G01G 19/44; G01G 19/08

(52) U.S. Cl. CPC B60R 25/31; B60R 25/04; G01G 19/08; B60R 25/2081; G01G 19/44; B60R 25/23

(57) ABSTRACT

A vehicle control apparatus includes a processor including hardware, the processor being configured to compare owner information characterizing an owner of a vehicle with user information characterizing a user seated in a driver's seat of the vehicle to determine whether or not the user is the owner, and perform, in a case where it is determined that the user is not the owner, at least one of restriction of use of the vehicle and notification to a terminal of the owner.

The present application claims priority to and incorporates by reference the entire contents of Japanese Patent Application No. 2020-095064 filed in Japan on May 29, 2020.

### BACKGROUND

The present disclosure relates to a vehicle control apparatus, a computer readable recording medium, and a vehicle control system.

JP 2016-037795 A discloses a technique for determining whether or not a driver is an owner of a vehicle on the basis of whether or not an electronic key is in a stationary state.

### SUMMARY

From the viewpoint of measures against relay attacks, popularization of carsharing, and the like, there is a need for a technique capable of accurately determining whether or not a person seated in a driver's seat of a vehicle is an owner of the vehicle.

According to one aspect of the present disclosure, there is provided a vehicle control apparatus including a processor including hardware, the processor being configured to compare owner information characterizing an owner of a vehicle with user information characterizing a user seated in a driver's seat of the vehicle to determine whether or not the user is the owner, and perform, in a case where it is determined that the user is not the owner, at least one of restriction of use of the vehicle and notification to a terminal of the owner.

### BRIEF DESCRIPTION OF THE DRAWINGS

FIG. 1 is a diagram schematically illustrating a vehicle control system including a vehicle control apparatus according to an embodiment;

FIG. 2 is a block diagram schematically illustrating a configuration of the vehicle control system including the vehicle control apparatus according to the embodiment;

FIG. 3 is a flowchart illustrating a first example of a processing procedure of a vehicle control method executed by the vehicle control apparatus according to the embodiment; and

FIG. 4 is a flowchart illustrating a second example of the processing procedure of the vehicle control method executed by the vehicle control apparatus according to the embodiment.

### DETAILED DESCRIPTION

A vehicle control apparatus, a computer readable recording medium storing a vehicle control program, and a vehicle control system according to an embodiment will be described with reference to the drawings. Note that components in the following embodiment include those which may be easily replaced by a person skilled in the art, or those which are substantially the same.

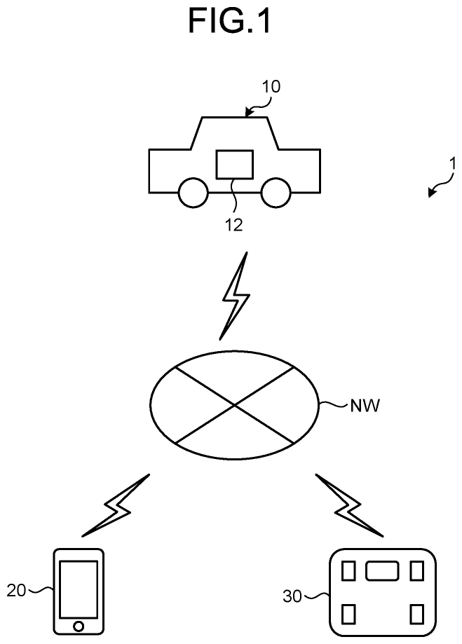

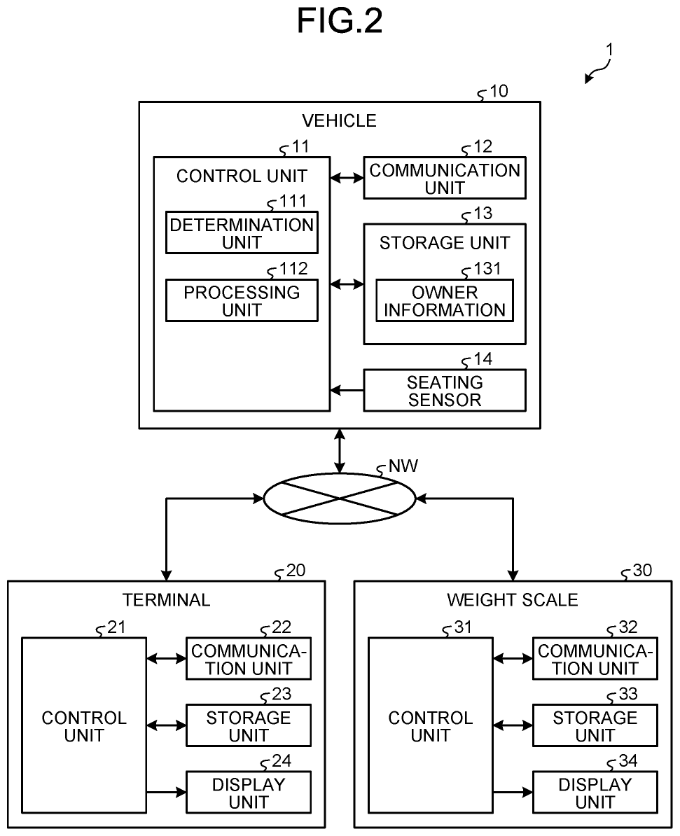

The vehicle control apparatus, the computer readable recording medium storing the vehicle control program, and the vehicle control system according to the present embodiment will be described with reference to FIGS. 1 and 2. The vehicle control apparatus, the computer readable recording medium storing the vehicle control program, and the vehicle control system according to the present embodiment are for determining whether or not a person seated in a driver's seat of a vehicle (hereinafter referred to as “user”) is an owner (or authorized user) of the vehicle, and for controlling the vehicle on the basis of a result of the determination.

A user in the present embodiment is a person who intends to use a vehicle, and includes a person other than an owner of the vehicle in addition to the owner of the vehicle. Examples of the person other than the owner of the vehicle include an authorized user who has obtained permission to use the vehicle from the owner in carsharing or the like, and a person who is neither the owner nor the authorized user of the vehicle.

As illustrated in FIG. 1, a vehicle control system 1 to which the vehicle control apparatus is applied includes a vehicle 10, a terminal 20, and a weight scale 30. The vehicle control apparatus according to the present embodiment is specifically implemented by a function of the vehicle 10. Note that the vehicle control system 1 only needs to include at least the vehicle 10 and the terminal 20, and the weight scale 30 is used only when the owner (or authorized user) is determined using the weight. The vehicle 10, the terminal 20, and the weight scale 30 each include a communication function, and may communicate with each other through a network NW. The network NW includes, for example, an Internet line network and a mobile phone line network.

The vehicle 10 is a mobile body capable of communicating with the outside, and as illustrated in FIG. 2, includes a control unit 11, a communication unit 12, a storage unit 13, and a seating sensor 14. The control unit 11 is an electronic control unit (ECU) that comprehensively controls operation of various components mounted on the vehicle 10. The control unit 11 physically includes a processor including a central processing unit (CPU), a digital signal processor (DSP), and a field-programmable gate array (FPGA), and a memory (main storage unit) including a random access memory (RAM) and a read only memory (ROM).

The control unit 11 loads a program stored in the storage unit 13 in a work area of the main storage unit, executes the program, and controls each component and the like through the execution of the program, thereby implementing a function matching a predetermined purpose. The control unit 11 functions as a determination unit 111 and a processing unit 112 through the execution of the program stored in the storage unit 13.

The determination unit 111 determines a user seated in a driver's seat. When detection information indicating that a user is seated is input from the seating sensor 14, the determination unit 111 determines whether or not the user is the owner by comparing owner information 131 stored in the storage unit 13 with user information.

The owner information 131 is information regarding the owner of the vehicle 10 and characterizes the owner. The owner information 131 is previously acquired from the owner and stored in the storage unit 13. Examples of the owner information 131 include a driving position of the owner (first driving position), the weight of the owner, and a weight range based on changes in the past weight of the owner. In addition, the driving position of the owner includes at least one of a seat position, a seat angle, a handle position, and a mirror angle when the owner is seated in the driver's seat of the vehicle 10.

A method of acquiring the driving position of the owner is not particularly limited. For example, a value may be manually input, or may be automatically acquired when the owner uses the vehicle 10 from a sensor or the like provided on a seat, a handle, a mirror, or the like. In addition, a method of acquiring the weight of the owner and the weight range based on the changes in the past weight is also not particularly limited. For example, values may be manually input, acquired by the seating sensor 14 when the owner uses the vehicle 10, or acquired from the weight scale 30 through the network NW.

The user information is information regarding a user seated in the driver's seat of the vehicle 10 and characterizes the user. The user information is acquired when the user is seated in the driver's seat of the vehicle 10. Examples of the user information include a driving position of the user (second driving position) and the weight of the user. In addition, the driving position of the user includes at least one of a seat position, a seat angle, a handle position, and a mirror angle when the user is seated in the driver's seat of the vehicle 10.

A method of acquiring the driving position of the user is not particularly limited. For example, a value may be manually input, or may be automatically acquired when the user is seated in the driver's seat of the vehicle 10 from the sensor or the like provided on the seat, the handle, and the mirror. In addition, a method of acquiring the weight of the user is also not particularly limited. For example, a value may be manually input, acquired by the seating sensor 14 when the user is seated in the driver's seat of the vehicle 10, or acquired from the weight scale 30 through the network NW.

More specifically, the determination unit 111 determines whether or not at least one of preset conditions is satisfied by comparing the owner information 131 with the user information. The conditions include, for example, a first condition that an absolute value of a difference between the driving position of the owner and the driving position of the user is greater than a predetermined reference, a second condition that an absolute value of a difference between the weight of the owner and the weight of the user is greater than a predetermined reference, and a third condition that an absolute value of a difference between an upper or lower limit value of the weight range of the owner and the weight of the user is larger than a predetermined reference. The predetermined reference in each of the conditions may be experimentally determined in advance. When determining that at least one of the first to third conditions is satisfied, the determination unit 111 determines that the user is not the owner of the vehicle 10.

Note that the determination unit 111 may determine whether or not the user is an authorized user in addition to whether the user is the owner. The authorized user indicates a person who has obtained permission to use the vehicle 10 from the owner. As a method of determining the authorized user, for example, it is possible to use a method of requesting a password decided by the owner in advance, a method of requesting presentation of a QR code (registered trademark) distributed (transmitted) to the user by the owner in advance, or biometric authentication using biometric information (fingerprint, retina, iris, face, voice, and the like) of the user registered in advance.

The processing unit 112 controls the vehicle 10 on the basis of a determination result of the determination unit 111. When the determination unit 111 determines that a user seated in the driver's seat of the vehicle 10 is not the owner of the vehicle 10, the processing unit 112 performs at least one of restriction of use of the vehicle 10 and notification to the terminal 20 of the owner. The restriction of use of the vehicle 10 is, for example, at least one of prohibition of starting of an engine of the vehicle 10 and a request of a password for starting of the engine. Note that a method of requesting the password is not particularly limited. For example, a request may be presented by an image or voice using a car navigation system or the like provided in the vehicle 10, or may be presented by an image or voice by using a terminal or the like owned by the user.

Note that, when the determination unit 111 determines whether or not the user is an authorized user in addition to whether the user is the owner, the processing unit 112 performs different processing according to a result of the determination. For example, when the determination unit 111 determines that the user is an authorized user, the processing unit 112 notifies the terminal 20 of the owner. On the other hand, when the determination unit 111 determines that the user is not an authorized user, the processing unit 112 restricts use of the vehicle 10.

The communication unit 12 includes, for example, a data communication module (DCM), and communicates with the terminal 20 and the weight scale 30 by wireless communication via the network NW.

The storage unit 13 includes a recording medium such as an erasable programmable ROM (EPROM), a hard disk drive (HDD), and a removable medium. Examples of the removable medium include a universal serial bus (USB) memory and a disc recording medium such as a compact disc (CD), a digital versatile disc (DVD), and a Blu-ray (registered trademark) disc (BD). In addition, the storage unit 13 may store an operating system (OS), various programs, various tables, various databases, and the like. The storage unit 13 stores the owner information 131.

The seating sensor 14 is provided in the driver's seat of the vehicle 10 and detects whether or not a user is seated in the driver's seat and the weight of the user. Then, the seating sensor 14 outputs detected information to the control unit 11.

The terminal 20 is for receiving a notification from the vehicle 10. Examples of the terminal 20 include a smartphone, a mobile phone, a tablet terminal, a wearable computer, and a personal computer, which are owned by the owner. The terminal 20 includes a control unit 21, a communication unit 22, a storage unit 23, and a display unit 24. Physical configurations of the control unit 21 and the storage unit 23 are similar to those of the control unit 11 and the storage unit 13.

The communication unit 22 includes, for example, a local area network (LAN) interface board and a wireless communication circuit for wireless communication. The communication unit 22 is connected to the network NW such as the Internet serving as a public communication network. In addition, the communication unit 22 communicates with the vehicle 10 by connecting to the network NW.

The display unit 24 includes, for example, a liquid crystal display (LCD) and an organic EL display (OLED), and displays information under the control of the control unit 21. For example, when a user seated in the driver's seat of the vehicle 10 is not the owner of the vehicle 10, the display unit 24 displays a notification to that effect.

The weight scale 30 is for measuring the weight of a user. The weight scale 30 is a so-called an Internet of Things (IoT) weight scale capable of communicating with the outside. The weight scale 30 includes a control unit 31, a communication unit 32, a storage unit 33, and a display unit 34. Physical configurations of the control unit 31, the communication unit 32, the storage unit 33, and the display unit 34 are similar to those of the control unit 21, the communication unit 22, the storage unit 23, and the display unit 24. Note that the display unit 34 displays the weight of a user of the weight scale 30.

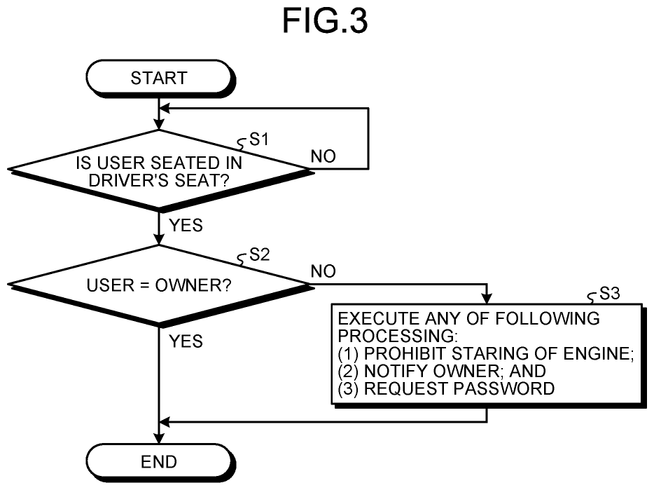

A first example of a processing procedure of a vehicle control method executed by the vehicle control apparatus according to the present embodiment will be described with reference to FIG. 3. In this example, a case will be described in which it is determined whether a user is the owner and predetermined processing is performed when the user is not the owner.

First, the determination unit 111 determines whether or not a user is seated in the driver's seat of the vehicle 10 on the basis of detection information of the seating sensor 14 (Step S1). When determining that the user is seated in the driver's seat of the vehicle 10 (Yes in Step S1), the determination unit 111 determines whether or not the user is the owner (Step S2). In Step S2, when determining that all of the first to third conditions are not satisfied, the determination unit 111 determines that the user is the owner of the vehicle 10. On the other hand, when determining that at least one of the first to third conditions is satisfied, the determination unit 111 determines that the user is not the owner of the vehicle 10.

When determining that the user is the owner (Yes in Step S2), the determination unit 111 ends this flow. On the other hand, when it is determined that the user is not the owner (No in Step S2), the processing unit 112 executes any of the following processing (Step S3), and ends this flow. Note that, in Step S1, when determining that the user is not seated in the driver's seat of the vehicle 10 (No in Step S1), the determination unit 111 returns to Step S1.

(1) Prohibit starting of the engine

(2) Notify the terminal 20 of the owner

(3) Request a password for starting of the engine

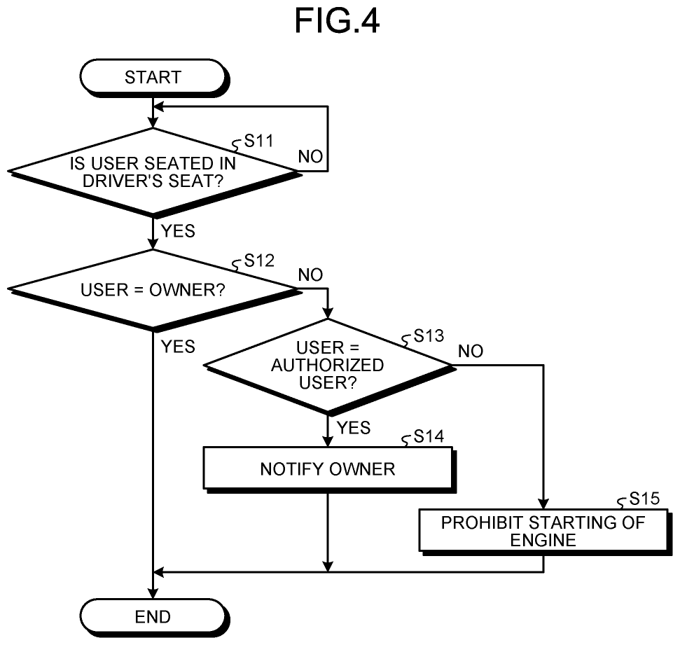

A second example of the processing procedure of the vehicle control method executed by the vehicle control apparatus according to the present embodiment will be described with reference to FIG. 4. In this example, a case will be described in which it is determined whether a user is an authorized user in addition to whether the user is the owner, and different types of processing are performed between a case where the user is not the owner and a case where the user is not an authorized user.

First, the determination unit 111 determines whether or not a user is seated in the driver's seat of the vehicle 10 on the basis of detection information of the seating sensor 14 (Step S11). When determining that the user is seated in the driver's seat of the vehicle 10 (Yes in Step S11), the determination unit 111 determines whether or not the user is the owner (Step S12). Note that a specific determination method in Step S12 is similar to that in Step S2 of FIG. 3.

When determining that the user is the owner (Yes in Step S12), the determination unit 111 ends this flow. On the other hand, when determining that the user is not the owner (No in Step S12), the determination unit 111 determines whether or not the user is an authorized user (Step S13).

When it is determined that the user is an authorized user (Yes in Step S13), the processing unit 112 notifies the terminal 20 of the owner (Step S14), and ends this flow. When it is determined that the user is not an authorized user (No in Step S13), the processing unit 112 prohibits starting of the engine of the vehicle 10 (Step S15), and ends this flow. Note that, in Step S11, when determining that the user is not seated in the driver's seat of the vehicle 10 (No in Step S11), the determination unit 111 returns to Step S11.

According to the vehicle control apparatus, the computer readable recording medium storing the vehicle control program, and the vehicle control system 1 according to the present embodiment described above, it is possible to accurately determine whether or not a user seated in the driver's seat of the vehicle 10 is the owner of the vehicle 10. In addition, according to the vehicle control apparatus, the computer readable recording medium storing the vehicle control program, and the vehicle control system 1 according to the present embodiment, when a user seated in the driver's seat is not the owner of the vehicle 10, use of the vehicle 10 may be restricted, the terminal 20 of the owner may be notified, and the like. Therefore, for example, even when a door of the vehicle 10 is illegally unlocked by, a relay attack by a malicious third party, theft of the vehicle 10 may be prevented.

In addition, according to the vehicle control apparatus, the computer readable recording medium storing the vehicle control program, and the vehicle control system 1 according to the present embodiment, since the owner may easily control the vehicle 10 under authority of the owner, it is possible to contribute to popularization of carsharing using the vehicle 10.

According to the present disclosure, it is possible to accurately determine whether or not a person seated in a driver's seat of a vehicle is an owner of the vehicle.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle control apparatus comprising
a processor comprising hardware, the processor being configured to:
compare owner information characterizing an owner of a vehicle with user information characterizing a user seated in a driver's seat of the vehicle to determine whether or not the user is the owner; and
perform, in a case where it is determined that the user is not the owner, at least one of restriction of use of the vehicle and notification to a terminal of the owner.

2. The vehicle control apparatus according to claim 1, wherein the processor is configured to:
compare the owner information with the user information to determine whether or not at least one of preset conditions is satisfied; and
determine, in a case where it is determined that the at least one of the conditions is satisfied, that the user is not the owner.

3. The vehicle control apparatus according to claim 2, wherein
the owner information is a first driving position including at least one of a seat position, a seat angle, a handle position, and a mirror angle when the owner is seated in the driver's seat,
the user information is a second driving position including at least one of a seat position, a seat angle, a handle position, and a mirror angle when the user is seated in the driver's seat, and
the at least one of the conditions includes a first condition that an absolute value of a difference between the first driving position and the second driving position is greater than a predetermined reference.

4. The vehicle control apparatus according to claim 2, wherein
the owner information includes a weight of the owner,
the user information includes a weight of the user, and
the at least one of the conditions includes a second condition that an absolute value of a difference between the weight of the owner and the weight of the user is greater than a predetermined reference.

5. The vehicle control apparatus according to claim 2, wherein
the owner information includes a weight range based on changes in a past weight of the owner,
the user information includes the weight of the user, and
the at least one of the conditions includes a third condition that an absolute value of a difference between an upper or lower limit value of the weight range and the weight of the user is greater than a predetermined reference.

6. The vehicle control apparatus according to claim 1, wherein the restriction of use of the vehicle is at least one of prohibition of starting of an engine and a request of a password for starting of the engine.

7. The vehicle control apparatus according to claim 1, wherein the processor is configured to:
determine, in a case where it is determined that the user is not the owner, whether or not the user is an authorized user who has obtained use permission from the owner;
notify the terminal of the owner in a case where it is determined that the user is the authorized user; and
restrict use of the vehicle in a case where it is determined that the user is not the authorized user.

8. A non-transitory computer-readable recording medium on which an executable program is recorded, the program causing a processor of a computer to execute:
comparing owner information characterizing an owner of a vehicle with user information characterizing a user seated in a driver's seat of the vehicle to determine whether or not the user is the owner; and
performing, in a case where it is determined that the user is not the owner, at least one of restriction of use of the vehicle and notification to a terminal of the owner.

9. The non-transitory computer-readable recording medium according to claim 8, wherein the program causes the processor to execute:
comparing the owner information with the user information to determine whether or not at least one of preset conditions is satisfied; and
determining, in a case where it is determined that the at least one of the conditions is satisfied, that the user is not the owner.

10. The non-transitory computer-readable recording medium according to claim 9, wherein
the owner information is a first driving position including at least one of a seat position, a seat angle, a handle position, and a mirror angle when the owner is seated in the driver's seat,
the user information is a second driving position including at least one of a seat position, a seat angle, a handle position, and a mirror angle when the user is seated in the driver's seat, and
the at least one of the conditions includes a first condition that an absolute value of a difference between the first driving position and the second driving position is greater than a predetermined reference.

11. The non-transitory computer-readable recording medium according to claim 9, wherein
the owner information includes a weight of the owner,
the user information includes a weight of the user, and
the at least one of the conditions includes a second condition that an absolute value of a difference between the weight of the owner and the weight of the user is greater than a predetermined reference.

12. The non-transitory computer-readable recording medium according to claim 9, wherein
the owner information includes a weight range based on changes in a past weight of the owner,
the user information includes the weight of the user, and
the at least one of the conditions includes a third condition that an absolute value of a difference between an upper or lower limit value of the weight range and the weight of the user is greater than a predetermined reference.

13. The non-transitory computer-readable recording medium according to claim 8, wherein the restriction of use of the vehicle is at least one of prohibition of starting of an engine and a request of a password for starting of the engine.

14. The non-transitory computer-readable recording medium according to claim 8, wherein the program causes the processor to execute:
determining, in a case where it is determined that the user is not the owner, whether or not the user is an authorized user who has obtained use permission from the owner;
notifying the terminal of the owner in a case where it is determined that the user is the authorized user; and
restricting use of the vehicle in a case where it is determined that the user is not the authorized user.

15. A vehicle control system comprising:
a vehicle comprising a first processor comprising hardware, the first processor being configured to
compare owner information characterizing an owner of a vehicle with user information characterizing a user seated in a driver's seat of the vehicle to determine whether or not the user is the owner, and
perform, in a case where it is determined that the user is not the owner, at least one of restriction of use of the vehicle and notification to a terminal of the owner; and
a terminal comprising a second processor comprising hardware, the second processor being configured to present the notification acquired from the vehicle to the owner.

16. The vehicle control system according to claim 15, wherein the first processor is configured to:
compare the owner information with the user information to determine whether or not at least one of preset conditions is satisfied; and
determine, in a case where it is determined that the at least one of the conditions is satisfied, that the user is not the owner.

17. The vehicle control system according to claim 16, wherein
the owner information is a first driving position including at least one of a seat position, a seat angle, a handle position, and a mirror angle when the owner is seated in the driver's seat,
the user information is a second driving position including at least one of a seat position, a seat angle, a handle position, and a mirror angle when the user is seated in the driver's seat, and
the at least one of the conditions includes a first condition that an absolute value of a difference between the first driving position and the second driving position is greater than a predetermined reference.

18. The vehicle control system according to claim 16, wherein
the owner information includes a weight of the owner,
the user information includes a weight of the user, and
the at least one of the conditions includes a second condition that an absolute value of a difference between the weight of the owner and the weight of the user is greater than a predetermined reference.

19. The vehicle control system according to claim 16, wherein
the owner information includes a weight range based on changes in a past weight of the owner,
the user information includes the weight of the user, and
the at least one of the conditions includes a third condition that an absolute value of a difference between an upper or lower limit value of the weight range and the weight of the user is greater than a predetermined reference.

20. The vehicle control system according to claim 16, wherein the restriction of use of the vehicle is at least one of prohibition of starting of an engine and a request of a password for starting of the engine.
